(19) United States
(12) Patent Application Publication
(10) Pub. No.: US 2025/0202249 A1
(43) Pub. Date: Jun. 19, 2025

(54) BATTERY CHAINING

(71) Applicant: Goal Zero LLC, Draper, UT (US)

(72) Inventors: Sterling Robison, Cottonwood Heights, UT (US); Alex J. Stout, West Jordan, UT (US); Martin Camacho-Leon, Sandy, UT (US); Zachary Garrard, Taylorsville, UT (US)

(21) Appl. No.: 18/986,439

(22) Filed: Dec. 18, 2024

Related U.S. Application Data
(60) Provisional application No. 63/612,037, filed on Dec. 19, 2023.

(51) Int. Cl. H02J 7/00

(52) U.S. Cl. CPC H02J 7/0019; H02J 7/0031; H02J 7/0047; H02J 7/007182; H02J 2207/20

(57) ABSTRACT

An electrical energy supply system may include multiple battery units each configured to store electrical energy and an electrical bus configured to be coupled to a load and provide the electrical energy stored in the battery units to the load. The system may also include multiple switches coupled between the electrical bus and the battery units. The switches may be configured to electrically couple each of the battery units to the electrical bus in at least one of a first connection state and a second connection state. The system may further include a system controller coupled to the switches. The system controller may be configured to control the switches to selectively couple each of the battery units to the electrical bus via the first connection state or the second connection state.

### CROSS-REFERENCE TO RELATED APPLICATIONS

This patent application claims priority to U.S. Provisional Patent Application Ser. No. 63/612,037, filed Dec. 19, 2024, which is incorporated herein by reference in its entirety.

### FIELD

The embodiments discussed herein are related to battery chaining.

### BACKGROUND

The demand for portable electronic devices, electric vehicles, renewable energy storage systems, has continued to increase and resulting in multiple different battery solutions. In many circumstances, it may be useful to chain or interconnect batteries with varying capacities, chemistries, voltages, and/or states of charge. Traditional battery chaining methods often assume homogeneity among the batteries in terms of capacity, chemistries, voltages, and/or states of charge. Such methods, when applied to batteries with varying capacities, chemistries, voltages, or states of charge, may lead to issues such as imbalanced charge and discharge cycles, overheating, reduced overall efficiency, and potential safety hazards. These problems may significantly reduce the operational lifespan of batteries chained in this manner.

The subject matter claimed herein is not limited to embodiments that solve any disadvantages or that operate only in environments such as those described above. Rather, this background is only provided to illustrate one example technology area where some embodiments described herein may be practiced.

### SUMMARY

An electrical energy supply system may include multiple battery units each configured to store electrical energy and an electrical bus configured to be coupled to a load and provide the electrical energy stored in the battery units to the load. The system may also include multiple switches coupled between the electrical bus and the battery units. The switches may be configured to electrically couple each of the battery units to the electrical bus in at least one of a first connection state and a second connection state. The system may further include a system controller coupled to the switches. The system controller may be configured to control the switches to selectively couple each of the battery units to the electrical bus via the first connection state or the second connection state.

### BRIEF DESCRIPTION OF THE DRAWINGS

Example embodiments will be described and explained with additional specificity and detail through the use of the accompanying drawings in which:

FIG. 1A illustrates an example environment for battery chaining;

FIG. 1B illustrates another example environment for battery chaining;

FIG. 2A illustrates another example environment for battery chaining;

FIG. 2B illustrates an example battery unit;

FIG. 3 illustrates another example environment for battery chaining;

FIG. 4 illustrates a flowchart of an example method to chain batteries;

FIG. 5 illustrates a flowchart of another example method to chain batteries; and

FIG. 6 illustrates an example system that may be used when chaining batteries.

### DETAILED DESCRIPTION

Battery power systems may be configured to provide power to other systems. For example, battery-powered systems may include one or more battery units. The battery units may be chained together to provide additional amperage and/or total energy for the battery system. In some circumstances, the voltages of the battery units may be approximately equal for the battery units to operate together in the battery power system. Some known battery power systems may adjust the voltages of the battery units to an approximately equal value by stepping up or stepping down the voltages. Stepping up and/or stepping down voltages of battery units may be difficult in some circumstances and/or may require much additional hardware and or circuitry. The additional hardware and or circuitry may result in additional costs to the system.

Alternately or additionally, in some circumstances, battery units used by battery-powered systems may be of different types. For example, some of the battery units may be acid-base battery units and some of the battery units may be lithium-ion-based battery units. In these circumstances, the battery units may have different voltage curves such that the voltage of one battery unit may drop faster than the voltage drops in a second battery unit. In these circumstances, it may be difficult to chain the battery units of different battery types together in a system because each battery type may behave differently.

The present disclosure describes systems and methods that may manage multiple battery units that are chained together. In these and other embodiments, the battery units may be each coupled to an electrical bus via switches in either a first connection state, a second connection state, or a third connection state. In the first connection state, the battery units may be coupled to the electrical bus to draw energy from the electrical bus to charge the battery units or discharge energy to the electrical bus to discharge the battery units in a state to equalize the voltage of the battery units. Charging the battery units may increase the voltage of the battery unit. Discharging the battery units may decrease the voltage of the battery unit. In these and other embodiments, the first connection state may be configured to adjust the voltage of the battery unit and not to power a load coupled to the battery unit. In a second connection state, the battery may be coupled to the electric bus to provide energy to the electrical bus to power the load and/or charge other battery units coupled to the electrical bus. Depending on the voltage of the battery, the battery may also draw energy from the electrical bus in the second connection state. In a third connection state, the battery units may be electrically isolated from the electrical bus. For example, the battery units may be disconnected from the electrical bus by a switch.

In these and other embodiments, a system controller may monitor the voltage levels of the battery units and adjust the connection states of the battery units so that all the battery units connected in the second connection state may have an approximately equal voltage. In response to a battery unit not having an approximately equal voltage of the battery units connected in the second connection state, the battery unit may be connected to the electric bus in the first connection state to charge the battery unit and increase the voltage level of the battery unit until the battery unit achieves a voltage level that allows the battery unit to change back to the second connection state and provide power to a load. Alternately or additionally, the battery unit may be connected to the electric bus in the first connection state to discharge the battery unit and decrease the voltage level of the battery unit until the battery unit achieves a voltage level that allows the battery unit to change back to the second connection state and provide power to a load.

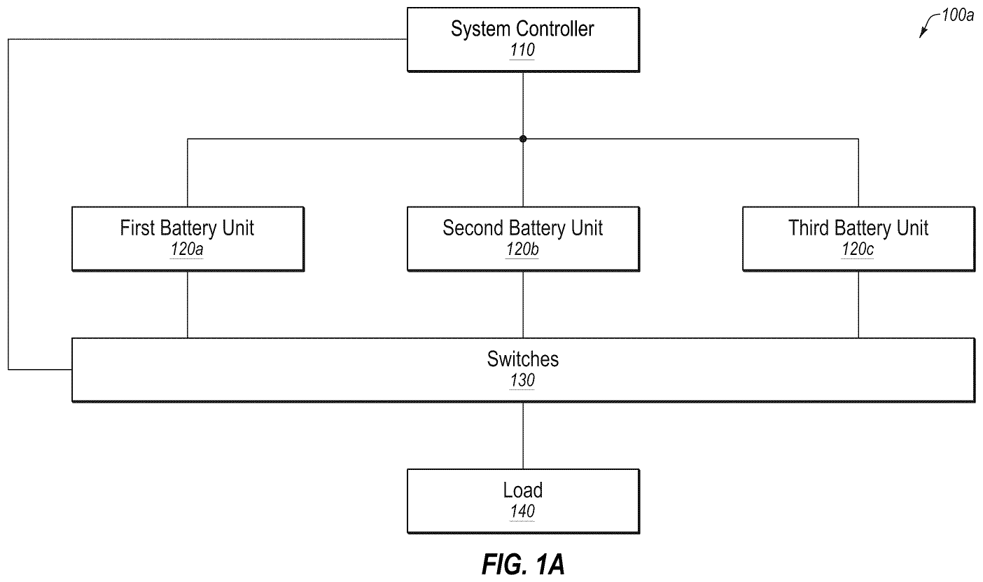

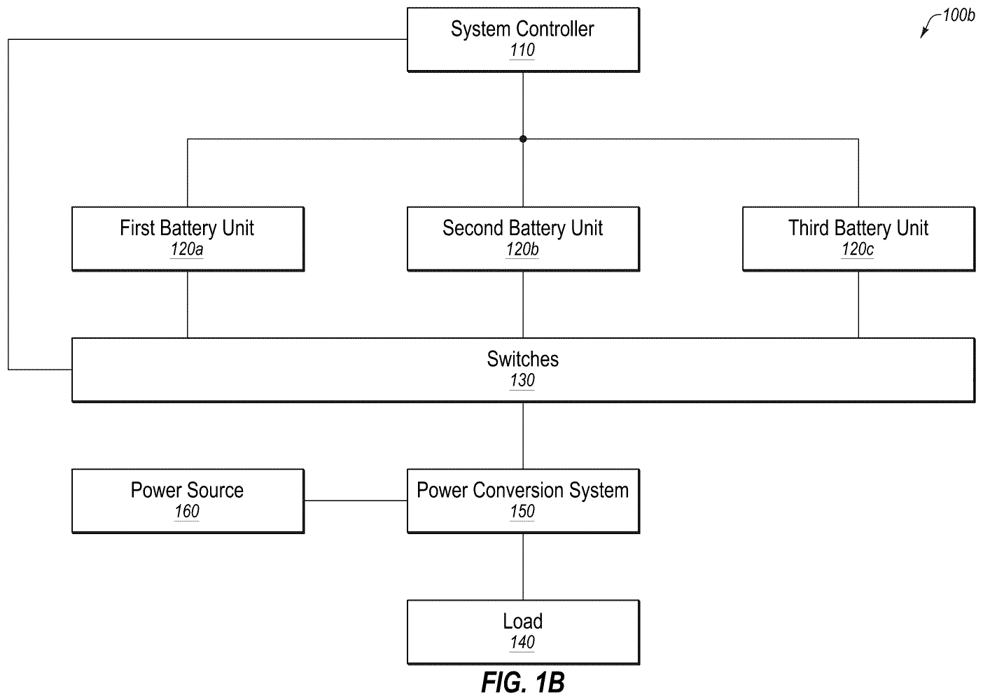

Turning to the figures, FIG. 1A illustrates an example environment 100a for battery chaining, in accordance with some embodiments of the present disclosure. The environment 100a may include a system controller 110, a first battery unit 120a, a second battery unit 120b, and a third battery unit 120c, referred to collectively as the battery unit(s) 120, switches 130, and a load 140.

Each of the battery units 120 may be any configuration of one or more batteries that are electrically coupled together to act as a single energy source. For example, a battery unit 120 may be a battery pack that may include a battery management system. The battery management systems may be configured to provide status data of the battery units 120. For example, the status data may include information regarding characteristics of the battery units 120. For example, the characteristics of the battery units 120 may include voltage level, state of charge, temperature, and total charge capacity, among other characteristics of the battery units 120. In some embodiments, each of the battery units 120 may be coupled to the system controller 110. In these and other embodiments, the battery units 120 may each provide the status data to the system controller 110.

In some embodiments, the battery units 120 may include any type of battery. For example, in some embodiments, the battery units 120 may each include the same type of batteries. For example, the battery units 120 may each include one or more lithium-ion, lead-acid, alkaline, lithium, lithium iron phosphate, nickel-metal hybrid, or lithium polymer type batteries, among other types of batteries. Alternately or additionally, some of the battery units 120 may include a first type of battery and others of the battery units 120 may include a second type of battery. Alternately or additionally, each of the battery units 120 may include a different type of battery.

In some embodiments, the switches 130 may be coupled between the battery units 120 and the load 140. The switches 130 may be configured to electrically couple the battery units 120 to an electrical bus in one of three connection states. In a first connection state, the battery units 120 may draw energy from the electrical bus. The battery units 120 may draw energy from the electrical bus to charge the batteries of the battery units 120. In charging the batteries of the battery units 120, the voltage level of the battery units 120 may increase. In the first connection state, the battery units 120 may not be directly electrically coupled to the electrical bus via only the switches 130. Rather, in the first connection state, the battery units 120 may be coupled to the switches 130 through a regulation device that is configured to adjust the voltage of the battery units 120. For example, the regulation device may be a battery charging device that is configured to charge the battery units 120 using power of the electrical bus or from another source to raise the voltage of the battery units 120. As another example, the regulation device may be a battery-discharging device that is configured to discharge the battery units 120 to lower the voltage of the battery units 120. In the first configuration, the battery units 120 may not provide power to the load 140.

In a second connection state, the battery units 120 may provide energy to the electrical bus based on the voltage of the battery units 120. The battery units 120 may provide energy by supplying current to the electrical bus that may be used by other devices that are drawing energy from the electrical bus. In the second connection state, the battery units 120 may be directly electrically coupled to the electrical bus via only the switches 130. Thus, the battery units 120 may act as a battery pack or a single battery unit that is configured to provide power to the load 140. Based on the voltage of battery units 120, in the second connection state, the battery units 120 may also sink current from the electrical bus. For example, if the voltage of a battery unit 120 drops below the voltage of other battery units 120, the battery unit 120 may sink some current due to the voltage difference between the battery units 120. However, the battery unit 120 while sinking some current may continue to be directly electrically coupled to the load 140 via the switches 130.

In some embodiments, the load 140 may be coupled to the electrical bus. The load 140 may be any type of device that consumes electrical energy. Thus, the load 140 may consume energy that is provided to the electrical bus by the battery units 120 that are connected to the electrical bus in the second connection state. In these and other embodiments, the load 140 may not be aware of the battery units 120. For example, the load 140 may not be aware of how many of the battery units 120 are connected to the electrical bus in the second connection state or which of the battery units 120 are connected to the electrical bus in the second connection state. Thus, the load 140 may consume electrical power from the electrical bus without knowledge of the connection states of the battery units 120 and independent of the connection states of the battery units 120.

In some embodiments, the switches 130 may be configured to individually switch each of the battery units 120 to the electrical bus. Thus, the battery units 120 may each be coupled to the electrical bus in either of the two connection states independent of how the other battery units 120 may be coupled to the electrical bus. In these and other embodiments, the switches 130 may be configured to operate to change the connection state of the battery units 120 between the first connection state and the second connection state. In these and other embodiments, the switches 130 may be configured to change the connection state of a battery unit 120 while the load 140 is drawing energy from the electrical bus. Furthermore, the switches 130 may be configured to change the connection state of the battery units 120 without knowledge of and independent of the power requirements of the load 140.

In some embodiments, the switches 130 may be coupled to the system controller 110. In these and other embodiments, the switches 130 may operate in response to signals from the system controller 110. For example, the system controller 110 may be configured to direct the switches 130 in which connection state to couple each of the battery units 120 to the electrical bus.

In some embodiments, the system controller 110 may be configured to determine a connection state for each of the battery units 120. In these and other embodiments, the system controller 110 may determine the connection state for each of the battery units 120 based on the status data obtained from the battery units 120. In some embodiments, the system controller 110 may determine the connection state for each of the battery units 120 based on one or more characteristics of the battery units 120. For example, the battery units 120 may determine the connection state of the battery units 120 based on the voltage levels of the battery units 120. For example, the battery units 120 with a voltage that is within a threshold voltage of a particular voltage may be assigned the second connection state and the other battery units 120 may be assigned the first connection state.

In some embodiments, the particular voltage may be predetermined at the manufacturing of the system controller 110. Alternately or additionally, the particular voltage may be set based on user input. In these and other embodiments, the particular voltage may be changed during operation of the example environment 100a based on user input.

Alternately or additionally, the particular voltage may be determined based on the types of the battery units 120 coupled to the system controller 110. For example, the system controller 110 may obtain information from the status data regarding the operating voltage levels of the battery units 120. In these and other embodiments, the system controller 110 may determine the particular voltage based on the operating voltage levels of the battery units 120. For example, the battery units 120 may have operating voltage levels of 12, 24, 48, or 60 volts, among other operating voltage levels when the battery units 120 are not under load and are fully charged.

Alternately or additionally, the particular voltage may be determined based on the voltages of the battery units 120 reported in the status data to the system controller 110. For example, the particular voltage may be a highest voltage reported in the status data. Alternately or additionally, the particular voltage may be a mathematical combination of one or more of the voltages reported in the status data. For example, if there are two or more voltages within a threshold voltage of one another, the particular voltage may be a medium or mean of the two or more voltages.

As noted, the battery units 120 with a voltage that is within the threshold voltage of the particular voltage may be assigned the second connection state. In some embodiments, the threshold voltage may be based on the configuration of the connections between the battery units 120 and the configuration of the switches 130. Alternately or additionally, the threshold voltage may be based on the power requirements of the load 140 and/or the environment 100a. Note that the size of the threshold voltage may determine an amount of current that may flow between the battery units 120 in the second connection state through the electrical bus. Thus, the threshold voltage may be selected based on the amount of current that may flow between the battery units 120 in the second connection state. In these and other embodiments, the threshold voltage may be a set voltage, such as 0.2, 0.5, 0.8, 1.0, 1.2, 1.5, 2.0, 2.5, or more volts. Alternately or additionally, the threshold voltage may be a percentage of the particular voltage. For example, the threshold voltage maybe 0.2, 0.5, 0.8, 1.0, 1.2, 1.5, 2.0, or 2.5 percent of the particular voltage.

After determining the connection state for each of the battery units 120, the system controller 110 may direct the switches 130 to connect the battery units 120 to the electrical bus according to connection states of the battery units 120. For example, the system controller 110 may open and/or close one or more switches such that each of the battery units 120 are connected to the electrical bus according to the connection states of the battery units 120.

In some embodiments, the system controller 110 may be configured to continue to monitor the battery units 120 while the battery units 120 are providing energy to the load 140. For example, the battery units 120 may continue to provide status information to the system controller 110. The system controller 110 may use the status information to adjust the connection states of the battery units 120. For example, a battery unit may change from the first connection state to the second connection state. Alternately or additionally, a battery unit may change from the second connection state to the first connection state. As an example, a first battery unit may have a voltage that is below a particular voltage more than the threshold voltage such that the first connection state is selected for the first battery unit. After charging through the first connection state, the voltage of the first battery unit may rise to be within the threshold voltage of the particular voltage. As a result, the first battery unit may be changed to the second connection state to allow the first battery unit to supply energy to the load 140.

As another example, the first battery unit may have a first voltage that is the highest voltage and selected as the particular voltage. The first voltage may decrease faster than voltages of other battery units. As a result, after some time of providing energy, the first voltage may not be the highest. As a result, a second voltage of a second battery unit may be selected as the particular voltage. In these and other embodiments, in response to the first voltage not satisfying the threshold voltage with respect to the second voltage, the connection state of the first battery unit may be changed to the second connection state. As a result, the first battery unit which may have been providing energy to the load may change to drawing energy from the electrical bus to charge.

Modifications, additions, or omissions may be made to FIG. 1A without departing from the scope of the present disclosure. For example, in some embodiments, the environment 100a may include more or fewer than the three battery units 120. For example, the example environment 100a may include two, four, five, six, seven, eight, nine, ten, twelve, fifteen, twenty, or more battery units 120. In these and other embodiments, the number of switches 130 may increase for the number of battery units 120 in the environment 100a to allow each of the battery units 120 to be coupled to the electrical bus.

As another example, the battery unit may have a third connection state where the battery units are not electrically coupled to the electrical bus. In these and other embodiments, the system controller 110 may determine, based on the status data, to not couple a battery unit to the electrical bus. In these and other embodiments, the battery unit may be placed in the third connection state. As an example, a battery unit may be coupled to the system controller 110 and the switches 130. In these and other embodiments, a particular voltage may be selected for the electrical bus. The battery unit may have the highest voltage that is not within a threshold voltage of the particular voltage. As a result, the battery unit may not be coupled to the electrical bus in the second connection state. Further, the system controller 110 may determine to not charge the battery unit via the first connection state because even when fully charged the battery unit may not be connected to the electrical bus via the second connection state due to the lower voltage levels of the battery unit. In these and other embodiments, the system controller 110 may select a different particular voltage.

In some embodiments, the system controller 110 may change the connection states of other of the battery units based on the new particular voltage. For example, the system controller 110 may adjust the connection states of other battery units until the voltages of the other battery units are at the particular voltage. For example, for two battery units with voltages higher than the particular voltage, the system controller 110 may connect a first battery unit via the second connection state and a second battery unit via the third connection state. After the voltage of the first battery unit decreases to the particular voltage, the first battery unit may be connected via the third connection state and the second battery unit via the second connection state to decrease the voltage of the second battery unit. After the voltage of the second battery unit decreases to the particular voltage, the connection state of the first battery unit may be changed to the second connection state and both the first and second battery units may provide energy to the electrical bus.

As another example, the switches 130 may be included in each of the battery units 120. For example, each of the battery units 120 may include the switches that may determine the connection state for each of the battery units 120. In these and other embodiments, the battery units 120 may each provide the status data to the system controller 110. In response to receiving the status data, the system controller 110 may determine the connection states for each of the battery units 120. The system controller 110 may direct commands to each of the battery units 120 for changing the respective switches to the determined connection state for each of the battery units 120.

In some embodiments, in the first connection state, the battery units 120 may be discharged to reduce the voltage of the battery units 120. In these and other embodiments, in the first connection state a voltage of a battery unit 120 may be reduced to be within the threshold voltage of the particular voltage system. Thus, in place of rising the voltages of the battery units 120, the voltages may be reduced such that the voltages of the battery units 120 in the second connection state are within the threshold voltage. As an example, a first battery unit may have a voltage that is above a particular voltage more than the threshold voltage such that the first connection state is selected for the first battery unit. After discharging through the first connection state, the voltage of the first battery unit may decrease to be within the threshold voltage of the particular voltage. As a result, the first battery unit may be changed to the second connection state to allow the first battery unit to supply energy to the load 140.

Alternately or additionally, in some embodiments, in the first connection state, some of the battery units 120 may be discharged to reduce the voltage of the battery units 120 and some of the battery units 120 may be charged to increase the voltage of the battery units 120. In these and other embodiments, whether a battery unit 120 is discharged or charged may vary based on a type of the battery unit 120, when the battery unit 120 is coupled to the system controller 110, among other criteria.

FIG. 1B illustrates an example environment 100b for battery chaining, in accordance with some embodiments of the present disclosure. The environment 100b may include the system controller 110, the battery units 120, the switches 130, and the load 140. The environment 100b may further include a power conversion system 150 and a power source 160.

In some embodiments, the power conversion system 150 may be coupled between the switches 130 and the load 140. In these and other embodiments, the power conversion system 150 may be configured to adjust the voltage/amperage provided by the battery units 120 to the load 140. For example, the power conversion system 150 may step-up or step-down the voltage provided by the battery units 120 to the load 140. For example, the battery units 120 may output a voltage of 45 volts and the power conversion system 150 may step-up the voltage to a 120 volts for delivery to the load 140.

In some embodiments, the power source 160 may be coupled to the power conversion system 150. In these and other embodiments, the power source 160 may be configured to provide power to the load 140 in place of the battery units 120 providing power to the load 140. In these and other embodiments, the battery units 120 may be in the third connection state. Alternately or additionally, the power source 160 may be used to charge the battery units 120. In these and other embodiments, the battery units 120 may be in the first connection state. In these and other embodiments, electrical energy from the power source 160 may be provided to the battery units 120 through the switches 130 to charge batteries of the battery units 120.

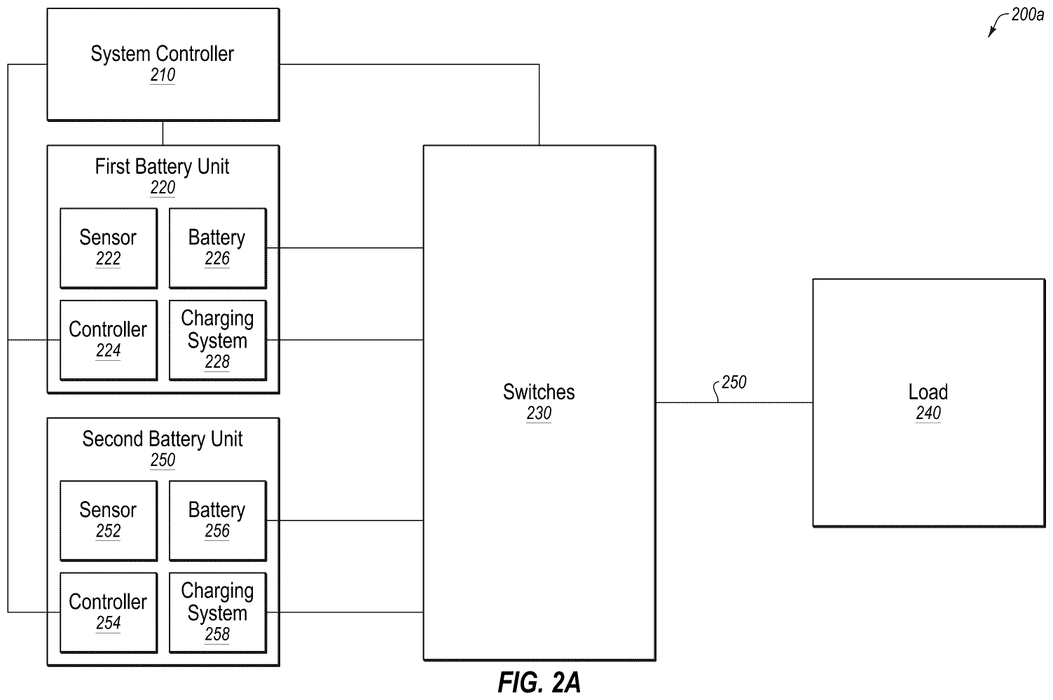

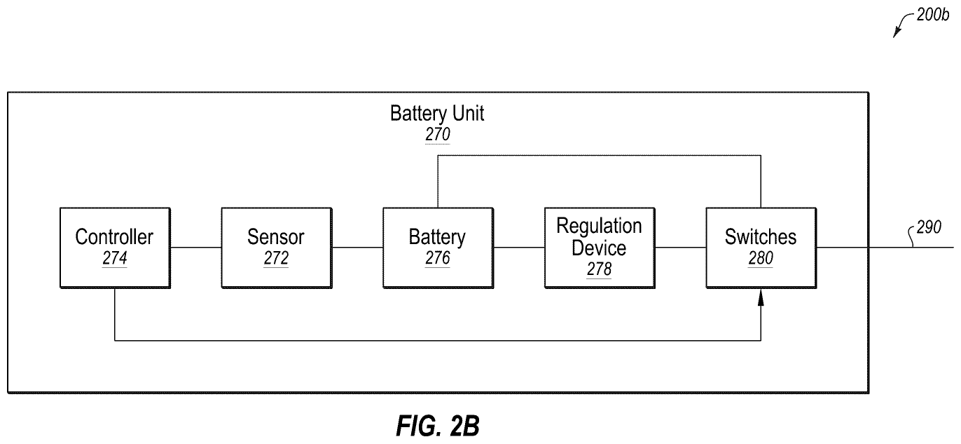

In some embodiments, the switches 130 may be distributed in the battery units 120, for example, as explained with respect to FIG. 2B. In these and other embodiments, the power conversion system 150 and the system controller 110 may be part of a single unit. In these and other embodiments, one or more of the battery units 120 may be included in the single unit with the power conversion circuit and the system controller 110. In these and other embodiments, the other battery units 120 may be separate units that are electrically coupled to the single unit via one or more wires.

FIG. 2A illustrates another example environment 200 for battery chaining, in accordance with some embodiments of the present disclosure. The environment 200 may include a system controller 210, a first battery unit 220, a second battery unit 250, switches 230, a load 240, and an electrical bus 260.

In some embodiments, the first battery unit 220 may include a first sensor 222, a first controller 224, a first battery 226, and a first charging system 228. The first sensor 222 may be configured to sense a voltage level of the first battery 226 and provide the voltage level to the first controller 224. The first controller 224 may be coupled to the system controller 210 and may be configured to provide the voltage level and other status data of the first battery unit 220 to the system controller 210.

In some embodiments, the first battery 226 may be one or more batteries coupled together in a manner to act as a single battery unit. The first battery 226 may be coupled to the electrical bus 260 via the switches 230 and configured to supply energy to the load 240 via the switches 230 and the electrical bus 260. The first charging system 228 may be coupled to the first battery 226 and the electrical bus 260 via the switches 230. The first charging system 228 may be configured to charge the first battery 226 by drawing energy from the electrical bus 260.

In some embodiments, the second battery unit 250 may include a second sensor 252, a second controller 254, a second battery 256, and a second charging system 258. The second sensor 252 may be configured to sense a voltage level of the second battery 256 and to provide the voltage level to the second controller 254. The second controller 254 may be coupled to the system controller 210 and may be configured to provide the voltage level and other status data of the second battery unit 250 to the system controller 210.

In some embodiments, the second battery 256 may be one or more batteries coupled together in a manner to act as a single battery unit. In some embodiments, the second battery 256 may be the same or a different type of battery than the first battery 226. The second battery 256 may be coupled to the electrical bus 260 via the switches 230 and configured to supply energy to the load 240 via the switches 230 and the electrical bus 260. The second charging system 258 may be coupled to the second battery 256 and the electrical bus 260 via the switches 230. The first charging system 228 may be configured to charge the second battery 256 by drawing energy from the electrical bus 260.

In some embodiments, the switches 230 may be coupled to the system controller 210, the first battery unit 220, the second battery unit 250, and the switches 230. The switches 230 may be controlled by the system controller 210. In these and other embodiments, the system controller 210 may direct the switches 230 to couple one of the first battery 226 and the first charging system 228 to the electrical bus 260 and to couple one of the second battery 256 and the second charging system 258 to the electrical bus 260. As such, the switches 230 may set the connection state of the first battery unit 220 and the second battery unit 250 to the electrical bus 260.

In some embodiments, the system controller 210 may be configured to obtain the status data from the first controller 224 and the second controller 254. The system controller 210 may obtain the status data via a communication bus that is wired and/or wireless. Based on the status data, the system controller 210 may be configured to adjust the connection states of the first battery unit 220, and the second battery unit 250. The system controller 210 may adjust the connection states of the first battery unit 220 and the second battery unit 250 by directing the switches 230 to change the connections between the first battery unit 220 and the second battery unit 250 and the electrical bus 260.

In some embodiments, the system controller 210 may be configured to determine the connection states of the first battery unit 220 and the second battery unit 250 and to direct the switches 230 to adjust the connection states as described in this disclosure. For example, the system controller 210 may continually, periodically, randomly, in response to inputs, or at some other intervals, obtain status data from the first controller 224 and the second controller 254. In response to obtaining the status data, the system controller 210 may determine a connection state for each of the first battery unit 220 and the second battery unit 250 and direct the switches 230 to the determined connection state. Sometimes the determined connection state may be the same as a previous connection state and other times the determined connection state may be different than a previous connection state.

In some embodiments, the environment 200 may be configured for coupling and decoupling of additional battery units. For example, the environment 200 may be configured to dynamically adjust a number of battery units coupled to the switches 230 and the system controller 210 within a range. The range may be determined based on the configuration of the switches 230 and the system controller 210. For example, a communication bus between the system controller 210 and the battery units may be configured to handle between 1 and 8 battery units, and the switches 230 may be configured to handle between 1 and 6 battery units. In these and other embodiments, between 1 and 6 battery units may be coupled to the electrical bus 260 without other changes to the system controller 210 and the switches 230.

Modifications, additions, or omissions may be made to FIG. 2A without departing from the scope of the present disclosure. For example, in some embodiments, the environment 200 may include additional battery units. For example, the environment 200 may include 3, 4, 5, 7, 9, 12, 15 or more battery units. In these and other embodiments, each of the battery units may be coupled to the system controller 210 and the switches 230. As another example, the environment 200 may include N number of battery units. Each of the battery units may include a battery, controller, a sensor, and a charging system. Alternately or additionally, each of the battery units may include switches that may set the connection states of the battery units. In these and other embodiments, the switches may not be combined in a separate device or circuit but may be integrated into the battery units. For example, the switches in a first battery unit may determine a connection state for the first battery unit.

As an example, FIG. 2B illustrates an example battery unit 270 that may be used in the environment 100a, 100b, or 200a. The battery unit 270 may include a sensor 272, a controller 274, a battery 276, a regulation device 278, and switches 280. The example battery unit 270 may be electrically coupled to an electrical bus 290. The sensor 272, the controller 274, and the battery 276 may be similar to the first sensor 222, the first controller 224, and the first battery 226 described with respect to FIG. 2A. As such, no further description is provided with respect to FIG. 2B.

In some embodiments, the regulation device 278 may be configured to charge or discharge the battery 276. For example, the regulation device 278 may obtain electrical energy from the electrical bus 290 to charge the battery 276. Alternately or additionally, the regulation device 278 may obtain electrical energy from the battery 276 and distribute the electrical energy to the electrical bus 290. In these and other embodiments, the regulation device 278 may adjust the voltage of the electrical energy between the battery 276 and/or the electrical bus 290. For example, when obtaining electrical energy from the battery 276, the regulation device 278 may step down the voltage from the battery 276 to match the voltage of the electrical bus 290 and provide the electrical energy to the electrical bus 290.

In some embodiments, the switches 280 may be configured to set the connection state of the example battery unit 270 with the electrical bus 290. For example, in a first connection state, the switches 280 may be configured to couple the regulation device 278 to the switches 280 and to disconnect the battery 276 from the electrical bus 290. In these and other embodiments, when the battery 276 has a voltage that is lower than a voltage of the electrical bus 290, the regulation device 278 may obtain electrical energy from the electrical bus 290 and provide electrical energy to the battery 276 to charge the battery 276 and raise the voltage of the battery 276. Alternately or additionally, the battery 276 may have a voltage higher than the electrical bus 290. In these and other embodiments, the regulation device 278 may disperse electrical energy from the battery 276 onto the switches 280.

In some embodiments, in a second connection state, the switches 280 may be configured to directly electrically connect the battery 276 to the electrical bus 290. In these and other embodiments, the battery 276 may directly provide electrical energy to the electrical bus 290. Modifications, additions, or omissions may be made to FIG. 2B without departing from the scope of the present disclosure. For example, in some embodiments, the battery unit 270 may include other systems or devices.

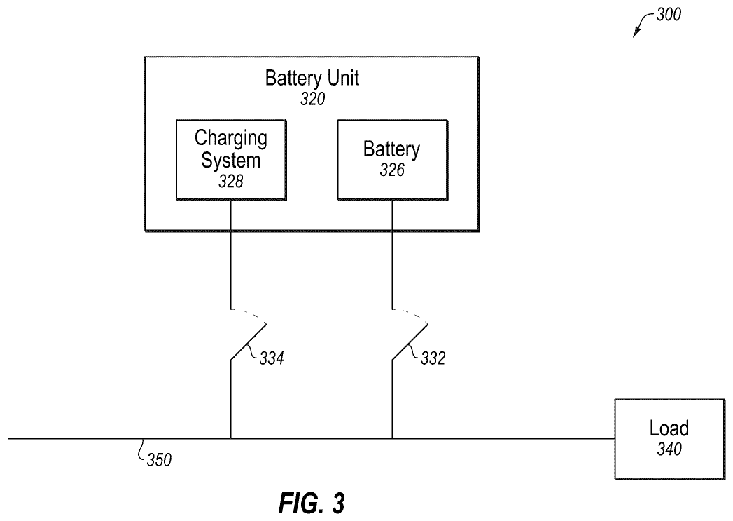

FIG. 3 illustrates another example environment 300 for battery chaining, in accordance with some embodiments of the present disclosure. The environment 300 may include a battery unit 320 that includes a battery 326, a charging system 328, a first switch 332, a second switch 334, a load 340, and an electrical bus 350.

In some embodiments, the battery unit 320 may be a stand-alone unit that may be moved separately from other battery units. In these and other embodiments, the battery unit 320 may be configured to be coupled and decoupled from the first switch 332 and the second switch 334. Alternately or additionally, the battery unit 320 may be configured to supply status data to a system controller.

In some embodiments, the battery 326 may be one or more batteries coupled together to provide electrical energy. The charging system 328 may include one or more circuits that are configured to draw energy from the electrical bus 350 at a range of voltages to charge the battery 326 of the battery unit 320.

The first switch 332 may be configured to electrically couple and decouple the battery 326 from the electrical bus 350. When the first switch 332 is closed, the battery unit 320 may be in the second connection state and supplying energy to the load 340. In these and other embodiments, when the first switch 332 is closed the second switch 334 may be open.

The second switch 334 may be configured to electrically couple and decouple the charging system 328 from the electrical bus 350. When the second switch 334 is closed, the battery unit 320 may be in the first connection state and drawing energy from the electrical bus 350 to charge the battery 326. In these and other embodiments, when the second switch 334 is closed the first switch 332 may be open.

In some embodiments, both the first switch 332 and the second switch 334 may be open. In these and other embodiments, the battery unit 320 may be in a third connection state such that the battery unit 320 is not electrically coupled to the electrical bus 350.

The first switch 332 and the second switch 334 may be controlled by a system controller, such as the system controller 110 or 210 of FIGS. 1 and 2, respectively. In some embodiments, the first switch 332 and the second switch 334 may be simple switches. Alternately or additionally, one or both the first switch 332 and the second switch 334 may be switch circuits that include one or more electrical components. Alternately or additionally, both the first switch 332 and the second switch 334 may represent a switching circuit or switching system that is configured to perform the operations of the first switch 332 and the second switch 334 as described with respect to FIG. 3.

Modifications, additions, or omissions may be made to FIG. 3 without departing from the scope of the present disclosure. For example, in some embodiments, the environment 300 may include one or more additional battery units that each may be coupled to the electrical bus 350 via two or more switches. Alternately or additionally, the battery unit 320 may be coupled to the electrical bus 350 via more than the first switch 332 and the second switch 334. Alternately or additionally, the charging system 328 may be a discharging system that is configured to discharge the battery unit 320 to reduce the voltage of the battery unit 320.

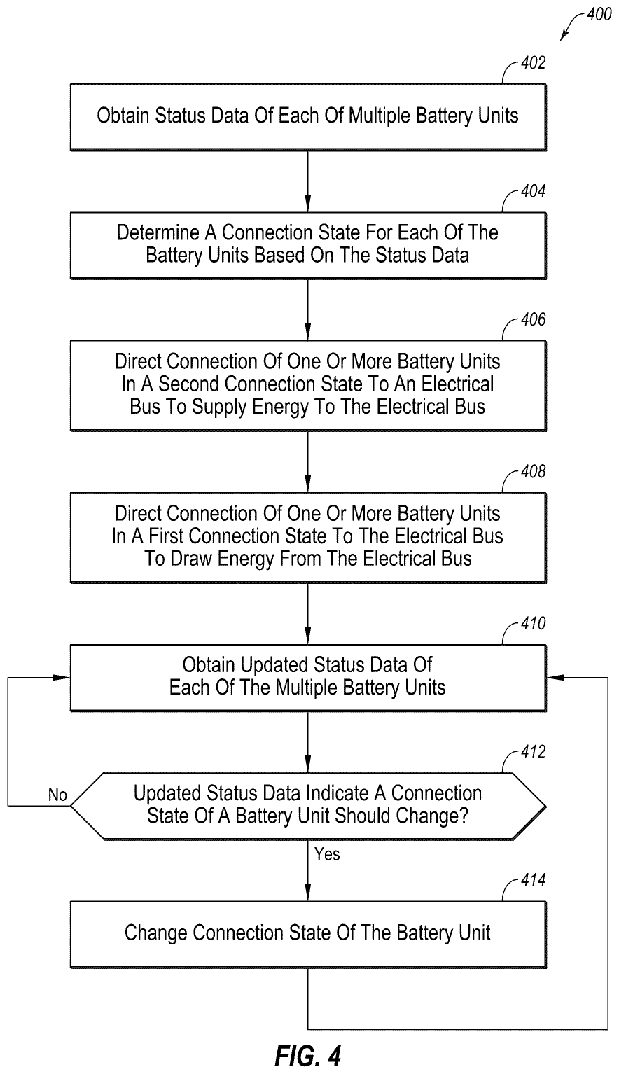

FIG. 4 illustrates a flowchart of an example method 400 to perform power combining. The method 400 may be arranged in accordance with at least one embodiment described in the present disclosure. One or more operations of the method 400 may be performed, in some embodiments, by a device or system, such as the system controller 110 or 210 of FIGS. 1 and 2 or another device or combination of devices or control systems. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 402, where status data of each of the multiple battery units may be obtained. For example, the status data may be obtained by a system controller, such as the system controller 110 or 210 of FIGS. 1 and 2. The status data may be generated by the battery units. The status data may include information regarding the health of the battery units. Alternately or additionally, the status data may include an indication of the voltage level of the battery units.

At block 404, a connection state for each of the battery units may be determined based on the status data. The connection state may be a first connection state or a second connection state. In some embodiments, the connection states of the battery units may be determined based on a particular voltage selected for the battery units in the second connection state. The particular voltage may be determined based on the highest voltage of the battery units. In these and other embodiments, the battery units with a voltage within a threshold voltage of the particular voltage may be determined to have the second connection state. The battery units with a voltage not within a threshold voltage of the particular voltage may be determined to have the first connection state.

At block 406, connection of one or more battery units in the second connection state to an electrical bus to supply energy to the electrical bus may be directed. In these and other embodiments, one or more switches may be directed to adjust a configuration to cause the battery units in the second connection state to supply energy to the electrical bus.

At block 408, connection of one or more battery units in the first connection state to the electrical bus to draw energy from the electrical bus may be directed. In these and other embodiments, one or more switches may be directed to adjust a configuration to cause the battery units in the first connection state to draw energy from the electrical bus. For example, the battery units may be coupled such that a battery charger in the battery unit is coupled to the electrical bus. As a result, the battery units may be charging from the battery units in the second connection state while the battery units in the second connection state are supplying energy to a load coupled to the electrical bus. In some embodiments, depending on the voltages of the battery units, none of the battery units may be in the first connection state. In these and other embodiments, operations of the block 408 may not be performed. Alternately or additionally, in the first connection states the battery units may discharge energy through a discharging system to reduce the voltage of the battery units.

At block 410, updated status data of each of the multiple battery units may be obtained. For example, after the connection states of the battery unit are set, the voltages of the battery units may be changed. For example, voltages of the battery units in the first connection state may increase and voltages of the battery units in the second connection state may decrease. For example, in response to a load being coupled to the electrical bus or some change in the load or an amount of time that a load is coupled to the electrical bus may result in an update of the status data.

At block 412, it may be determined when the updated status data indicates a connection state of a battery unit should change. A connection state of a battery unit may be determined to change in response to a voltage level of the battery unit changing to satisfy or not satisfy the threshold voltage. For example, in response to a battery unit changing to not satisfy the threshold voltage, the connection state of the battery unit may change from the second connection state to the first connection state.

In some embodiments, in response to a connection state of a battery unit being changed, the method 400 may proceed to block 414. In response to a connection state of a battery unit not being changed, the method 400 may proceed to block 410. At block 410, the method 400 may obtain further updated status data from the battery units.

At block 414, the connection state of the battery unit may be changed. For example, in response to a voltage of a battery unit in the first connection state increasing to be within a voltage threshold of a particular voltage, the connection state of the battery unit may change from the first connection state to the second connection state. As another example, in response to a voltage of a battery unit in the second connection state decreasing to be outside of the voltage threshold of the particular voltage, the connection state of the battery unit may change from the second connection state to the first connection state. In some embodiments, a first threshold voltage that results in a change from the first connection state to the second connection state may be different than a second threshold voltage that results in a change from the second connection state to the first connection state. For example, the first threshold voltage may be smaller than or larger than the second threshold voltage. For example, a first threshold voltage may be 0.5 volts and a second threshold voltage may be 1.0 volts. As a result, a battery unit may change from the first connection state to the second connection state in response to the battery unit having a voltage within 0.5 volts of a particular voltage. However, the battery unit may change from the second connection state to the first connection state in response to the battery unit having a voltage that is more than 1.0 volts different from the particular voltage.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

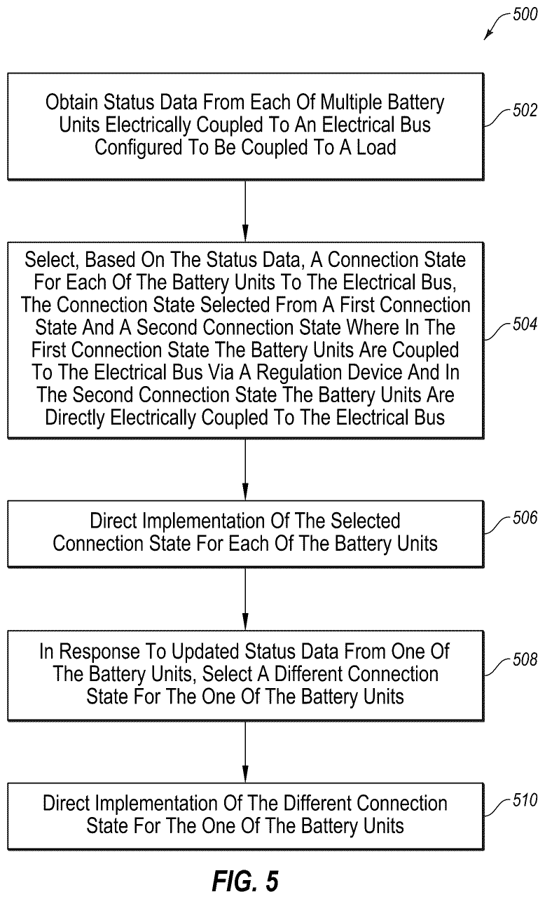

FIG. 5 illustrates a flowchart of an example method 500 to perform power combining. The method 500 may be arranged in accordance with at least one embodiment described in the present disclosure. One or more operations of the method 500 may be performed, in some embodiments, by a device or system, such as the system controller 110 or 210 of FIGS. 1 and 2 or another device or combination of devices or control systems. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where status data from each of multiple battery units coupled to an electrical bus configured to be coupled to a load may be obtained. In some embodiments, the status data may include voltage levels and the selecting the connection state may be based on comparing the voltage levels to a particular voltage.

At block 504, a connection state for each of the battery units to the electrical bus may be selected based on the status data. The connection state may be selected from a first connection state and a second connection state. In the first connection state the battery units are coupled to the electrical bus via a regulation device and in the second connection state the battery units are directly electrically coupled to the electrical bus.

In some embodiments, the connection state is selected from the first connection state, the second connection state, and a third connection state, where during the third connection state the plurality of battery units are isolated from the electrical bus.

In some embodiments, selecting the different connection state may be based on comparing the voltage levels to the particular voltage. In these and other embodiments, when the different connection state is the second connection state the comparison is done using a first threshold voltage and when the different connection state is the first connection state the comparison is done using a second threshold voltage that is different than the first threshold voltage. In these and other embodiments, the particular voltage may be determined based on the status data.

At block 506, implementation of the selected connection state for each of the battery units may be directed. In some embodiments, the directing implementation of the different connection state for the one of the battery units may occur while one or more of the battery units are in the second connection state and providing stored electrical energy to the load.

At block 508, in response to updated status data from one of the battery units, a different connection state for the one of the battery units may be selected. At block 510, implementation of the different connection state for the one of the battery units may be directed.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

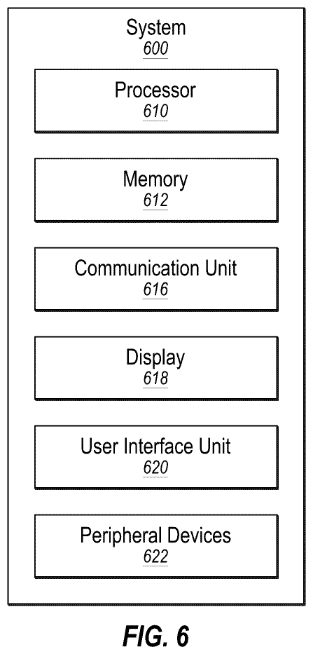

FIG. 6 illustrates an example system 600 that may be used with one or more embodiments provided in this disclosure. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure. For example, the system 600 or part of the system may be part of the system controller 110 or the battery units 120 of FIGS. 1A and 1B and may be configured to perform one or more of the tasks described above with respect to the system controller 110 or the battery units 120 of FIGS. 1A and 1B. Alternately or additionally, the system or parts of the system 600 may be part of the system controller 210, the first controller 224, or the second controller 254 of FIG. 2A, or part of the controller 274 of FIG. 2B and may be configured to perform the operations performed by the system controller 210, the first controller 224, the second controller 254, or the controller 274.

Generally, the processor 610 may include any suitable special-purpose or general-purpose computer, computing entity, or processing device including various computer hardware or software modules, and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to transcription presentation such that the system 600 may perform or direct the performance of the operations associated therewith as directed by the instructions. In these and other embodiments, the instructions may be used to perform one or more operations of the method 500 of FIG. 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present data as directed by the processor 610.

The user interface unit 620 may include any device to allow a user to interface with the system 600. For example, the user interface unit 620 may include a mouse, a trackpad, a keyboard, buttons, a camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices. In these and other embodiments, the microphone may be configured to capture audio. The imager may be configured to capture images. In some embodiments, the speaker may broadcast audio received by the system 600 or otherwise generated by the system 600.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special-purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general, such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence of a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An electrical energy supply system comprising: a plurality of battery units each configured to store electrical energy;
an electrical bus configured to be coupled to a load and provide the electrical energy stored in the plurality of battery units to the load;
a plurality of switches coupled between the electrical bus and the plurality of battery units, the plurality of switches configured to electrically couple each of the plurality of battery units to the electrical bus in at least one of a first connection state and a second connection state; and
a system controller coupled to the plurality of switches, the system controller configured to control the plurality of switches to selectively couple each of the plurality of battery units to the electrical bus via the first connection state or the second connection state.

2. The system of claim 1, wherein in the first connection state the plurality of battery units are coupled to the electrical bus via a regulation device and in the second connection state the plurality of battery units are directly electrically coupled to the electrical bus via the plurality of switches.

3. The system of claim 2, wherein the regulation device is configured to draw energy from the electrical bus to charge one or more batteries of one or more of the plurality of battery units connected to the electrical bus via the first connection state.

4. The system of claim 3, wherein the energy drawn from the electrical bus is provided by one or more batteries of one or more of the plurality of battery units connected to the electrical bus via the second connection state.

5. The system of claim 1, wherein the system controller is configured to direct the plurality of switches to change a connection state of one or more of the plurality of battery units while one or more of the plurality of battery units are in the second connection state and providing the electrical energy to the load.

6. The system of claim 5, wherein the connection state of one or more of the plurality of battery units changes from the first connection state to the second connection state or from the second connection state to the first connection state.

7. The system of claim 1, wherein the electrical bus includes a power converter configured to adjust a voltage of the electrical energy from the plurality of battery units before providing the electrical energy to the load.

8. The system of claim 1, wherein one or more of the plurality of battery units include one or more batteries of a first battery type and one or more of the plurality of battery units include one or more batteries of a second battery type that is different than the first battery type.

9. An electrical energy supply system comprising: a plurality of battery units, each of the plurality of battery units configured to store electrical energy and including a controller configured to provide status data;
an electrical bus configured to be coupled to a load and provide the electrical energy stored in the plurality of battery units to the load;
a plurality of switches coupled to the electrical bus and the plurality of battery units, the plurality of switches configured to electrically couple each of the plurality of battery units to the electrical bus in one of a first connection state and a second connection state, in the first connection state the plurality of battery units are coupled to the electrical bus via a regulation device and in the second connection state the plurality of battery units are directly electrically coupled to the electrical bus via the plurality of switches; and
a system controller coupled to the plurality of switches and the plurality of battery units, the system controller configured to:
obtain the status data from each of the plurality of battery units; and
control, based on the status data, the plurality of switches to selectively couple each of the plurality of battery units to the electrical bus via the first connection state or the second connection state.

10. The system of claim 9, wherein the regulation device is configured to draw energy from the electrical bus to charge one or more batteries of one or more of the plurality of battery units connected to the electrical bus via the first connection state.

11. The system of claim 10, wherein the energy drawn from the electrical bus is provided by one or more batteries of one or more of the plurality of battery units connected to the electrical bus via the second connection state.

12. The system of claim 9, wherein the system controller is configured to control the plurality of switches based on the status data such that the one or more battery units coupled to the electrical bus via the second connection state include a voltage within a threshold voltage of a particular voltage.

13. The system of claim 12, wherein the system controller is configured to determine the particular voltage based on the status data from one or more of the plurality of battery units.

14. The system of claim 9, wherein one or more of the plurality of battery units include batteries of a first battery type and one or more of the plurality of battery units include batteries of a second battery type that is different than the first battery type.

15. A method comprising:
obtaining status data from each of a plurality of battery units electrically coupled to an electrical bus configured to be coupled to a load;
selecting, based on the status data, a connection state for each of the plurality of battery units to the electrical bus, the connection state selected from a first connection state and a second connection state where in the first connection state the plurality of battery units are coupled to the electrical bus via a regulation device and in the second connection state the plurality of battery units are directly electrically coupled to the electrical bus;
directing implementation of the selected connection state for each of the plurality of battery units;
in response to updated status data from one of the plurality of battery units, selecting a different connection state for the one of the plurality of battery units; and
directing implementation of the different connection state for the one of the plurality of battery units.

16. The method of claim 15, wherein the directing implementation of the different connection state for the one of the plurality of battery units occurs while one or more of the plurality of battery units are in the second connection state and providing stored electrical energy to the load.

17. The method of claim 15, wherein the status data includes voltage levels and the selecting the connection state is based on comparing the voltage levels to a particular voltage.

18. The method of claim 17, wherein the selecting the different connection state is based on comparing the voltage levels to the particular voltage, wherein when the different connection state is the second connection state the comparison is done using a first threshold voltage and when the different connection state is the first connection state the comparison is done using a second threshold voltage that is different than the first threshold voltage.

19. The method of claim 17, further comprising determining the particular voltage based on the status data.

20. The method of claim 15, wherein the connection state is selected from the first connection state, the second connection state, and a third connection state, where during the third connection state the plurality of battery units are isolated from the electrical bus.
